(19) United States
(12) Patent Application Publication
(10) Pub. No.: US 2022/0039338 A1
(43) Pub. Date: Feb. 10, 2022

(54) FROST FREE LAWN SPRINKLER VALVE ASSEMBLY

(71) Applicant: MARK KABLE, SAGINAW, MI (US)

(72) Inventor: MARK KABLE, SAGINAW, MI (US)

(21) Appl. No.: 16/986,756

(22) Filed: Aug. 6, 2020

(51) Int. Cl. A01G 25/16; F16K 31/60; E03B 7/07

(52) U.S. Cl. CPC A01G 25/16; E03B 7/07; F16K 31/60

(57) ABSTRACT

A frost-free lawn sprinkler valve assembly comprising a shutoff of the water supply from the outside of a dwelling in which the assembly is located.

### BACKGROUND OF THE INVENTION

The applicant is unaware of any prior art within this field.

### THE INVENTION

The present invention is a frost-free lawn sprinkler valve assembly. The assembly comprises a water feed pipe connected to a water supply at a near end. The water feed pipe terminates inside a dwelling wall.

The water feed pipe connected by a plumbing union at a distal end to a water shut off assembly. The water shut off assembly extending through the dwelling wall and terminating in a shut off valve.

The water shut off assembly comprises a second pipe wherein the shut off valve is joined at a distal end of the second pipe, outside the dwelling wall, and, an expandable plug located inside the second pipe, inside the wall of the dwelling, the valve and the plug mechanically connected to each other by a rod, a flange fixedly encircling the second pipe against an outside and against a dwelling wall.

There is a backflow assembly connected to the water shut off assembly by a plumbing connection. The first segment of the backflow assembly connected to a drainpipe, a terminating end of the drainpipe is capped by a plumbing cap. The second segment of the backflow assembly is connected to the first segment and is connected to an underground water piping system by a plumbing connection.

### BRIEF DESCRIPTION OF THE DRAWINGS

FIG. 1 is a full side view of the frost-free lawn sprinkler valve assembly.

FIG. 2 is a full front view of the frost-free lawn sprinkler valve assembly.

FIG. 3 is a full side view of the frost-free lawn sprinkler valve assembly.

FIG. 4 is a full back view of the frost-free lawn sprinkler valve assembly.

### DETAILED DESCRIPTION OF THE DRAWINGS

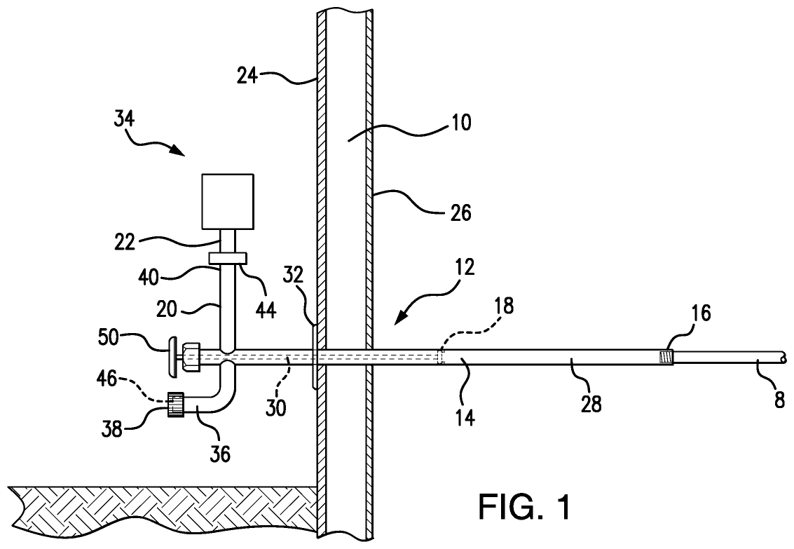

FIG. 1 shows frost-free lawn sprinkler valve 2 from the side. The present invention is a frost-free lawn sprinkler valve assembly. The assembly comprises a water feed pipe 4 connected to a water supply 6 at a near end 8. The water feed pipe 4 terminates inside a dwelling wall 26.

The water feed pipe 4 connected by a plumbing union 16 at a distal end 14 to a water shut off assembly 12. The water shut off assembly 12 extending through the dwelling wall 10 and terminating in a shut off valve 18.

The water shut off assembly 12 comprises a second pipe 20 wherein the shut off valve 18 is joined at a distal end 22 of the second pipe 20, outside the dwelling wall 24, and, an expandable plug 28 located inside the second pipe 20, inside the wall 26 of the dwelling. The valve 44 and the plug 28 are mechanically connected to each other by a rod 30, a flange 32 fixedly encircling the second pipe 20 against an outside wall 24 and against the dwelling wall 10.

There is a backflow assembly 34 connected to the water shut off assembly 12 by a plumbing union connection 42. The first segment of the backflow assembly 34 is connected to a drainpipe 36. A terminating end 46 of the drainpipe 36 is capped by a plumbing cap 38. The second segment of the backflow assembly is connected to the first segment 40 and is connected to an underground water piping system 48 (sprinkler line) by a plumbing connection 16. The handle 50 operates the shut off valve 18.

Currently all residential sprinkler systems have a water shut off valve that must be closed for the technician to work on the sprinkler systems. This water shut of valve is located within the dwelling. This requires the homeowner to be present for the technician to shut off the water shut off valve.

It has been discovered that when winterizing or maintaining sprinkler systems the present invention allows the technician the ability to access the water shut off outside of the dwelling. This will save tremendous amounts to time and money for both the maintainer and the owner.

It has also been discovered that the ability to place the shut off hand outside while the actual shut off valve resides within the dwelling prevents frost/freeze damage, also saving time and money.

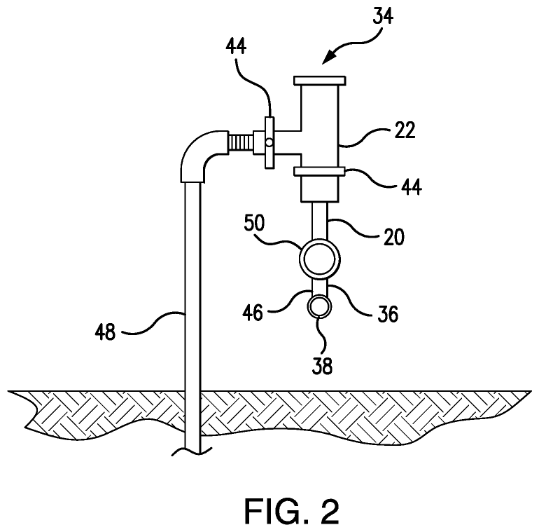

FIG. 2 shows frost-free lawn sprinkler valve 2 from the front. The backflow assembly 34 has a second pipe 20 with a distal end 22. There is a valve 44, a terminal end 48 and a down pipe 48. The down pipe is the line that feeds the sprinkler valve system. Also shown is the handle 50 that controls the shut off valve 18.

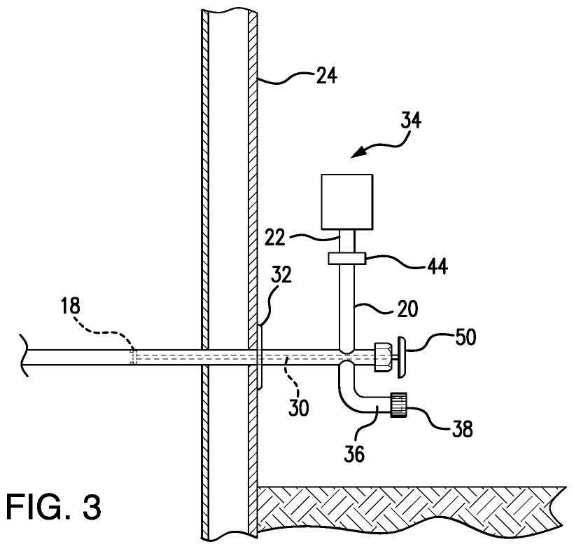

FIG. 3 shows the frost-free lawn sprinkler valve 2 from the opposite side. Also shown is the aforementioned outside wall 24, the second pipe 20, and the distal end 22. In addition, the backflow assembly 34 featuring valve 44, the drainpipe 36 and the plumbing cap 38 are also shown. Also visible is the shutoff valve handle 50 and the rod 30 that controls the shutoff valve 18 within the dwelling.

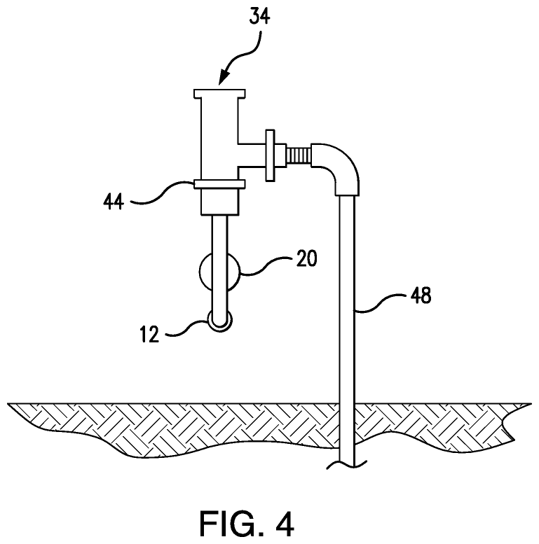

FIG. 4 shows frost-free lawn sprinkler valve 2 from the back. The backflow assembly 34 is shown along with the valve 44. Also, the down pipe 48 that feeds the sprinkler valve system leads into the ground.

What is claimed is:

1. A frost-free lawn sprinkler valve assembly, said assembly comprising:
A. a water feed pipe connectable to a water supply at a near end, said water feed pipe terminating inside a dwelling wall;
B. said water feed pipe connected by a plumbing union at a distal end to a water shut off assembly, said water shut off assembly extending through said dwelling wall and terminating in a shut off valve;
C. said water shut off assembly comprising a second pipe wherein said shut off valve is joined at a distal end of said second pipe, outside said dwelling wall, and, an expandable plug located inside said second pipe, inside said wall of said dwelling, said valve and said plug mechanically connected to each other by a rod, a flange fixedly encircling said second pipe against an outside wall and against said dwelling wall;
D. a backflow assembly connected to said water shut off assembly by a plumbing union connection, a first segment of said backflow assembly connected to a drain pipe, a terminating end of said drain pipe being capped by a plumbing cap, a second segment of said backflow assembly being connected to said first segment and being connected to an underground water piping system by a plumbing connection.
